(19) United States
(12) Patent Application Publication
(10) Pub. No.: US 2009/0162818 A1
(43) Pub. Date: Jun. 25, 2009

(54) Method for the determination of supplementary content in an electronic device

(76) Inventor: Martin Kosakowski, Bochum (DE)

Correspondence Address: Hollingsworth & Funk, LLC, 8009 34th Avenue South, Suite 125, Minneapolis, MN, 54425, US

(21) Appl. No.: 12/004,683

(22) Filed: Dec. 21, 2007

(51) Int. Cl. G09B 19/06

(52) U.S. Cl. 434/157

(57) ABSTRACT

The invention relates to a method for replacing subtitle text with occasional word or idiom translations. In the method an initial language skill is determined. A content object is selected for presentation. A content vocabulary associated with the content object is determined. The content vocabulary is reduced based on the initial language skill to produce a target vocabulary. The presentation of said content object is started in the electronic device. The presence of a word in the content object is detected. The translation of the word is displayed on a display of the electronic device, if the word belongs to the target vocabulary.

### BACKGROUND OF THE INVENTION

1. Field of the Invention

The invention relates to the presentation of digital media in an electronic device. Particularly, the invention relates to a method for the determination of supplementary content in an electronic device.

2. Description of the Related Art

Information technology is widely used in language teaching and self-study. There exists a wide range of computer applications for language learning. The applications range from more conventional on-line dictionaries and interactive listening comprehension tests to hypermedia presentations and computer games. In hypermedia presentations a user may click on visual symbols to discover their names. In computer games a user may be required to enter instructions in a foreign language in order to proceed through phases and scenes. Many of these applications are indeed useful for the learning of the basics. Improving the language skills to a level where it is possible to follow films or to read books intended for a native speaker is demanding and the motivation is often lost in the pursuit. Further, it is often very difficult to improve one's vocabulary beyond the limits of a certain basic vocabulary, because self-study dictionaries often list only a few thousand most common words. New words studied from a mere dictionary are mostly forgotten due to the lack of a context where the words are used. The dictionaries in many cases do teach examples, but they are fragmentary. Even in literature many uncommon words used by authors achieve an artistic effect, but may turn out to be obsolete and lack a present day usage. It would be useful for a student to be able to select a topic of interest, for example, as a basis for the self-study. The topic could be represented in a film, an audio recording or a multimedia presentation. The challenge is to activate and sustain intrinsic motivation of the user, which may be done best, when short term goals for language improvement are enjoyable for the user. The problem with existing DVD-films, for example, is that turning off the subtitles may prove to be too challenging and the recognition of unfamiliar words for dictionary lookup is difficult, whereas the providing of subtitles often makes the watcher too lazy to try to follow the original audio track.

It would be beneficial to be able to have a solution which enables the following of films and other multimedia presentations with reduced subtitles in an electronic device.

### SUMMARY OF THE INVENTION

The invention relates to a method, which comprises: determining at least one initial language skill parameter in an electronic device; selecting a content object for presentation in said electronic device; determining a learning content associated with said content object; adjusting said learning content based on said at least one initial language skill parameter to obtain a target learning content; and presenting said target learning content in association with of said content object in said electronic device, said target learning content having a presentation timing dependent on said content object.

The invention relates also to a system comprising: a network server configured to determine at least one initial language skill parameter, to select a content object for presentation by an electronic device, to determine a learning content associated with said content object, to adjust said learning content based on said at least one initial language skill parameter to obtain a target learning content, and to provide said target learning content to said electronic device; and said electronic device configured to present said target learning content in association with said content object, said target learning content having a presentation timing dependent on said content object.

The invention relates also to an electronic device comprising: an application entity configured to determine at least one initial language skill parameter, to select a content object for presentation, to determine a learning content associated with said content object, to adjust said learning content based on said at least one initial language skill parameter to produce a target learning content; and a media presentation entity configured to present said target learning content in association with said content object, said target learning content having a presentation timing dependent on said content object.

The invention relates also to an electronic device comprising: means for determining at least one initial language skill parameter; means for selecting a content object for presentation; means for determining a learning content associated with said content object; means for adjusting said learning content based on said at least one initial language skill parameter to produce a target learning content; and means for presenting said target learning content in association with of said content object, said target learning content having a presentation timing dependent on said content object.

The invention relates also to an electronic device comprising: an application entity configured to determine at least one initial language skill parameter, to select a content object for presentation, to locate a learning content associated with said content object and said at least one initial language skill parameter; and a media presentation entity configured to present said target learning content in association with of said content object, said target learning content having a presentation timing dependent on said content object.

The invention relates also to an electronic device comprising: means for determining at least one initial language skill parameter; means for selecting a content object for presentation; means for obtaining a learning content associated with said content object and said at least one initial language skill parameter; means for presenting said target learning content in association with of said content object, said target learning content having a presentation timing dependent on said content object.

The invention relates also to a computer program embodied on a computer readable medium, the computer program comprising code for controlling a processor to execute a method comprising: determining at least one initial language skill parameter in an electronic device; selecting a content object for presentation in said electronic device; determining a learning content associated with said content object; adjusting said learning content based on said at least one initial language skill parameter to produce a target learning content; and presenting said target learning content in association with of said content object, said target learning content having a presentation timing dependent on said content object.

The invention relates also to a computer program embodied on a computer readable medium, the computer program comprising code for controlling a processor to execute a method comprising: determining at least one initial language skill parameter; selecting a content object for presentation; locating a learning content associated with said content object; obtaining a target learning content based on said at least one initial language skill parameter; and presenting said target learning content in association with of said content object, said target learning content having a presentation timing dependent on said content object.

In one embodiment of the invention, said learning content comprises at least one of a content vocabulary and a content grammar.

In one embodiment of the invention, said learning content comprises at least one of a translation of at least one word present in said learning content, at least one illustration of at least one word present in said learning content, an example of use of a grammar structure and a translation of said grammar structure.

In one embodiment of the invention, the electronic device further comprises: said media presentation entity configured to start a presentation of said content object, to detect a presence of a word or an expression in said content object, and to present for a predefined time a translation or a definition of said word or expression on a display of said electronic device, if said word or expression belongs to said target learning content. The predefined time may be, for example, a time interval dependent on the amount of data to be presented on the display. The predefined time may be, for example, set to end as a scene changes in the content object. The predefined time may also be, for example, a fixed time interval.

In one embodiment of the invention, the presentation timing for the target learning content is determined by the media presentation entity from information in the content object, which reveals the times when a given word, expression or grammar structure is used in the content object. Based on the presentation timing learning information from the target learning content is presented on the display of said electronic device. The presentation timing may be obtained from a voice media component, subtitle text media component or any media component providing timed indicators for words, expression or grammar structures in the content object.

In one embodiment of the invention, the electronic device further comprises: an application entity configured to determine at least one initial language skill parameter, to select a content object for presentation, to determine a learning content associated with said content object, to reduce said learning content based on said at least one initial language skill parameter to produce a target learning content; and a media presentation entity configured to start a presentation of said content object, to detect a presence of a word or an expression in said content object, and to present for a predefined time a translation or a definition of said word or expression on a display of said electronic device, if said word or expression belongs to said target learning content.

In one embodiment of the invention, the electronic device further comprises: said application entity configured to detect a critical word in said target learning content or said learning content, to determine an additional vocabulary related to said critical word and to add said additional vocabulary to said target learning content or said learning content.

In one embodiment of the invention, the electronic device further comprises: said application entity configured to present at least one word from said target learning content and a translation of said at least one word, to determine at least one second language skill parameter and to reduce said target learning content based on said at least one second language skill parameter.

In one embodiment of the invention, the electronic device further comprises: said application entity configured to associate a rank with each word in said learning content, to determine a rank based on said at least one initial language skill parameter, to remove each word with a rank lower than said rank.

In one embodiment of the invention, the electronic device further comprises: said application entity configured to request said learning content from a vocabulary server, said request comprising said at least one initial language skill parameter and a title of said content object; and to receive said target learning content to said electronic device.

In one embodiment of the invention, the electronic device further comprising: a multimedia reception entity configured to request the streaming of said content object from a streaming server, to receive at least one stream associated with said content object from said streaming server.

In one embodiment of the invention, the electronic device further comprises: said multimedia presentation entity configured to detect the pressing of a key, to determine the current displacement from the start of the content object in said content presentation, to determine at least one word or expression presented in the content object during a predefined time period before the current displacement and to present said at least one word or expression and a translation of said word or expression on a display of said electronic device.

In one embodiment of the invention, the electronic device further comprises: said multimedia presentation entity configured to detect the pressing of a key, to determine a current scene in the content object, to determine at least one word or expression presented during the scene and to present said at least one word or expression and a translation of said at least one word or expression on a display of said electronic device.

In one embodiment of the invention, the electronic device further comprises: said application entity configured to provide said at least one initial language skill parameter to a remote server.

In one embodiment of the invention, said content object comprises at least one of: an audiovisual recording, a video recording, an audio recording, a text file or a computer game.

In one embodiment of the invention, the content object may be a multimedia presentation comprising a number of media streams each media stream representing separate media components such as video, audio or subtitles.

In one embodiment of the invention, the content object is stored in the electronic device. The content object may be stored, for example, within a primary or secondary memory of the electronic device.

In one embodiment of the invention, the electronic device comprises a mobile communication device, which may be a cellular telephone, a mobile communicator, a personal digital assistant or a wireless local area network terminal.

In one embodiment of the invention, said mobile communication device is a mobile station in a mobile communication system, for example, in a cellular mobile communication system. In one embodiment of the invention, the mobile communication system comprises at least one of a Global System of Mobile Communications (GSM) network and a Universal Mobile Telephone System (UMTS) network, a Code Division Multiple Access (CDMA) network or any other cellular network. In one embodiment of the invention, the system comprises, for example, a Wireless Local Area Network (WLAN) or a Worldwide Interoperability for Microwave Access (WiMAX) network. In one embodiment of the invention, the mobile communication device may be, for example, a GSM mobile station, CDMA mobile station or a UMTS mobile station with a dual mode or multimode functionality to support different access types. However, the different networks and systems mentioned are just examples. The invention may be used in any relevant data system, as those familiar to the state of the art may easily understand.

In one embodiment of the invention, the computer program is stored on a computer readable medium. The computer readable medium may be a removable memory card, magnetic disk, holographic memory, optical disk or magnetic tape.

The embodiments of the invention described hereinbefore may be used in any combination with each other. Several of the embodiments may be combined together to form a further embodiment of the invention. A method, an electronic device, a network node or a computer program to which the invention is related may comprise at least one of the embodiments of the invention described hereinbefore.

The benefits of the invention are related to improvements in the presentation of translation information while watching audiovisual presentations using an electronic device.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1A is a block diagram illustrating the obtaining of a skill based vocabulary and grammar from a vocabulary and grammar server, user skill determination and the streaming of content from a streaming server to a mobile device in one embodiment of the invention;

FIG. 1B is a block diagram illustrating the determining of user skill in vocabulary and grammar by a vocabulary and grammar server together with a mobile device and the streaming of content to a separate display device in one embodiment of the invention;

FIG. 1C is a block diagram illustrating the determining of user skill in vocabulary and grammar and the presentation of a media content to a mobile device from a secondary memory in association with the mobile device in one embodiment of the invention;

FIG. 2 is a flow chart illustrating a method for supplementary content determination in one embodiment of the invention;

FIG. 3 is a block diagram illustrating an electronic device in one embodiment of the invention; and

FIG. 4 is a block diagram illustrating a screen with supplementary content in one embodiment of the invention.

### DETAILED DESCRIPTION OF THE EMBODIMENTS

Reference will now be made in detail to the embodiments of the present invention, examples of which are illustrated in the accompanying drawings.

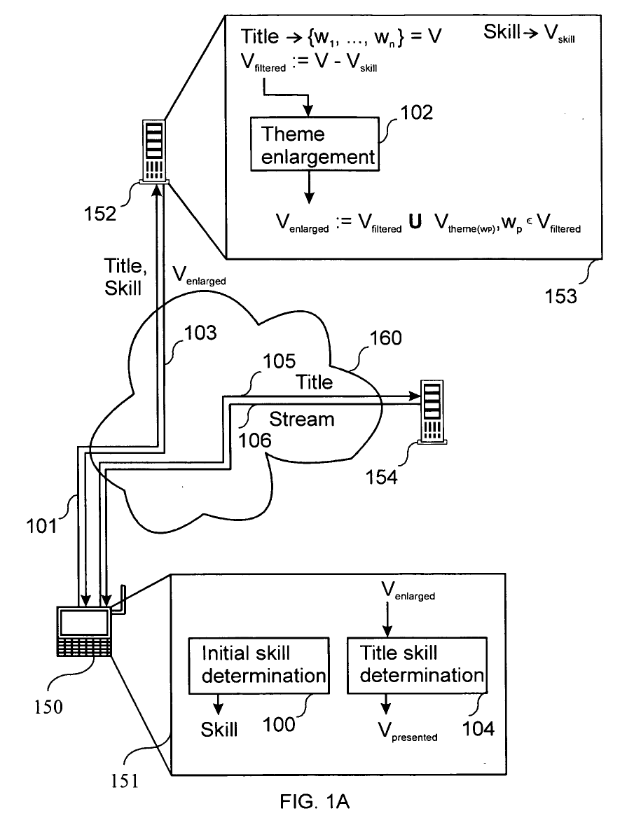

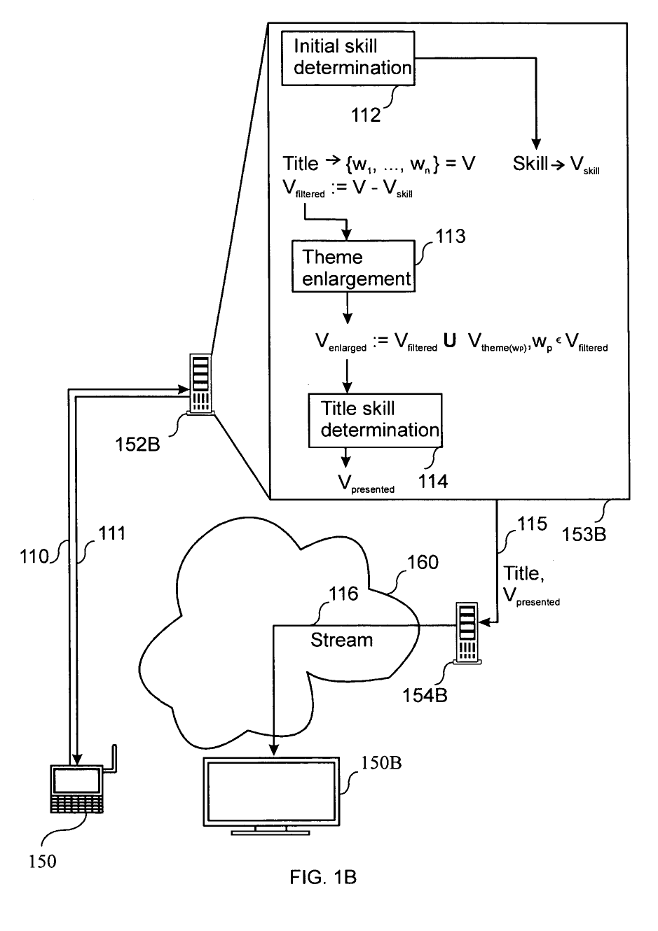

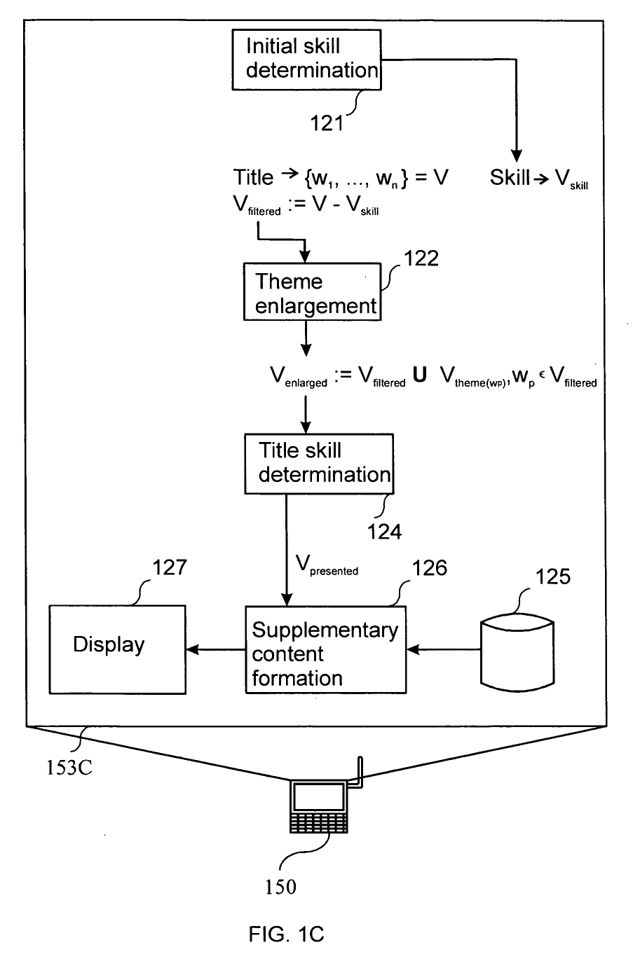

FIG. 1 is a block diagram illustrating the obtaining of a skill based vocabulary and grammar from a vocabulary and grammar server, user skill determination and the streaming or delivering of content from a streaming or delivering server to a mobile device, in one embodiment of the invention. In FIG. 1 there is a client device, which receives and displays media content, such as a mobile device 150, a vocabulary and grammar server 152 and a streaming server 154, which communicate via a network 160. The server 154, for example, a media content server, may also be storage of media content files that can be delivered as such. The internal functions of mobile device 150 pertaining to the determination of playback time vocabulary and grammar guidance are illustrated with box 151. The internal functions of vocabulary and grammar server 152 pertaining to the determination of a vocabulary based on a title and a skill provided are illustrated with box 153.

The starting point in FIG. 1 is that mobile device 150 is provided with an application 100 which determines the initial skill of the user of mobile device 150 in a given language. The initial skill determination, that is, testing may involve, for example, prompting the user for translations of a number of words, multiple choice quizzes, listening comprehension tests, even pronunciation tests and speech recognition. An initial skill may also be directly entered by the user manually to bypass the skill determination. The skill determined may be represented in mobile device 150 as a single natural number, an integer, a real number or as a vector comprising a number of elements, which may represent skills in different areas such as grammar, vocabulary and listening comprehension. After the skill has been determined in application 100, the user may choose a title, that is, a media presentation, as the basis for language self-study. The title may be chosen by the user from a list presented by vocabulary and grammar server 152. The title may be a movie, an audio recording, a video recording, a multimedia presentation, a song, a map, a text, a game or any combination of the aforementioned, or any other subject matter relevant for language self-study. In one embodiment, the list presented by the server may be a program/service listing, such as an Electronic Program Guide (EPG) or an Electronic Service Guide (ESG). Additionally, vocabulary and grammar server 152 may be a broadcasting entity/server for broadcasting radio or television signal and content. In one embodiment of the invention the title content may already reside in the user device 150. The title content may be stored in a memory of the device 150 or may be read from an attachable memory module, such as a CD/DVD, or a memory stick.

After the user has selected the title, a request message illustrated with arrow 101 is sent from mobile device 150 to vocabulary and grammar server 152. The request message comprises an identifier and/or metadata of the title, the user skill and a selection for vocabulary and/or grammar. Upon receiving the title identification, vocabulary and grammar server 152 maps the title to a vocabulary V, which is represented as a set of words V={w1, . . . , wn}. The user skill obtained in the request message is also mapped to a skill based vocabulary, that is, word set Vₛₖᵢₗₗ. A vocabulary may be represented as a text file where the words are separated by white space. In a vocabulary file the words may also be accompanied with their rank as determined from relative word frequencies in a sufficiently large corpus of texts. By the rank of a word is meant the order number of the word in a list formed by ordering the words of a language in a descending order according to the frequency of use. The most frequently used words have the lowest ranks, the word “the” having the rank 1 in English. The vocabulary files may comprise only the word stems where different word endings, that is, inflectional morphemes are removed. The vocabulary may also be enhanced with idioms, phrases, grammar examples and verb usage examples, which are treated hereinafter as words. Thereupon, from the set V is removed all words that belong to the set Vₛₖᵢₗₗ to obtain a new set V_{filtered}, which represents the vocabulary in the title mastered by the user at her skill level and which may be omitted from the vocabulary guidance presented to the user during the playback or the presentation of the title. In one embodiment of the invention, the words omitted from V_{filtered} are determined by mapping the user skill to a word rank above which all words are removed from the vocabulary V. For example, the 2000 most common words could be removed from the vocabulary V to yield the vocabulary V_{filtered} for a user with a skill level “intermediate=2”.

However, in order to avoid the spoiling of the plot in the title, it may be necessary to introduce additional vocabulary to the V_{filtered}. This is performed at theme enlargement box 102. This is achieved, for example, so that keywords critical to the plot are identified in vocabulary V_{filtered} and are used to add extra theme related words and possibly idioms to vocabulary V_{filtered}, which serve the purpose of concealing plot details. For example, for each identified word wₚ is determined a set V_{theme(wp)} by mapping word wₚ to the set V_{theme(wp)}. The set V_{theme(wp)} is added to the set V_{filtered} to yield the set V_{enlarged}. The set V_{theme(wp)} does not necessarily have to contain merely words related to the subject matter or theme of word wₚ, instead the set V_{theme(wp)} may contain words related to alternative plots and denouements. The sensitive words are marked manually, for example, by associating a sensitivity indicator bit with them. In one embodiment of the invention, extra words for plot concealment are added in one phase provided that at least one plot sensitive word remains in the set V_{filtered}. In one embodiment of the invention, the critical keywords V_{theme(wp)} of the plot are used as a minimum content of the V_{enlarged} to provide enjoyable presentation to a user.

As the set V_{enlarged} or V_{filtered} has been produced in vocabulary and grammar server 152, it is returned, for example, as a file to mobile device 150, as illustrated with arrow 103. Together with the set V_{enlarged} or V_{filtered} is provided also the translations for the words in the vocabulary. Also pictures, icons, applets, animation, sample usages and voice recordings for pronunciation aid may be provided in association with the words in the vocabulary. In one embodiment of the invention, also the ranks of the words are provided in the response.

Upon having received the vocabulary, the user may start practicing the vocabulary in an application 104. Application 104 obtains vocabulary V_{enlarged} or V_{filtered} and presents the words to the user together with their translations, usages, grammars and/or associated pictures. The words may be provided in a variety orders in order to conceal or reveal the plot better. Finally, application 104 presents a quiz to the user to determine the skill regarding the vocabulary associated with the title. The skill regarding the title may be represented as a score, for example, from 0% to 100% or simply as the set of words mastered. The user may not be allowed to proceed to the playback of the title before a threshold number of words are mastered or before the score exceeds a predefined threshold. In another embodiment of the invention the application 104 may enable playback of the title and obtained vocabulary immediately without any pre-practicing. The practicing may be requested after the playback and/or if the skill level after the playback doesn't improve.

In one embodiment of the invention, the score is mapped to a cutoff word rank. The words having a rank lower than the cutoff word rank are removed from vocabulary V_{enlarged} to yield the final vocabulary V_{presented}, which represents the words the translation of which is shown in the subtitles during the playback of the title.

In one embodiment of the invention, the set of words mastered are removed from the vocabulary V_{enlarged} to yield the final vocabulary V_{presented}, which represents the words the translation of which is shown in the subtitles during the playback of the title.

Upon completing the quiz in application 104, the streaming of the multimedia presentation corresponding to the title is started by mobile device 150. Mobile device 150 sends a stream set-up and a stream start request message to streaming server 154, as illustrated with arrow 105. The set-up request message may provide the title to indicate the correct video and audio objects to be streamed to the user. In addition to the video and audio streams, a connection or a stream for subtitle texts is also provided to mobile device 150 from streaming server 154, as illustrated with arrow 106. In one embodiment of the invention, a gaming application is started in mobile device 150 instead of the streaming.

As words not belonging to the final vocabulary V_{presented} are encountered in the subtitle stream, they are erased. As words belonging to the final vocabulary V_{presented} are encountered in the subtitle stream, the words are amended with a corresponding translation.

In one embodiment of the invention, the supplementary content in the form of word, idiom and grammar structure translations are presented when a tag is encountered in a media component stream provided from streaming server 154 to mobile device 150. In one embodiment of the invention, vocabulary and grammar server 152 provides a timing list in association with V_{enlarged}. The timing list specifies the times when specific words, idioms and grammar structures are audible in the audio stream of the multimedia presentation.

In one embodiment of the invention, the media streams are transmitted from mobile device 150 to an external display device, which may also comprise loudspeakers for the rendering of the audio content. The media streams may be transmitted over a wireless connection such as a Bluetooth™ connection or a wired connection.

In one embodiment of the invention, the user may choose to switch of the showing of the word translations or may choose to switch to normal subtitles. This is, for example, done by providing a key in the keypad of mobile device 150 to switch between modes such as “subtitles, no-subtitles, word translations”.

In one embodiment of the invention, the user is provided with a key in the keypad of mobile device 150 to pause the presentation or streaming while presenting the translations of the words from V_{presented} encountered in a predefined timeframe in the stream before the pressing of the key is detected. The timeframe may also be a scene as defined in the title recording. The user may be provided with keys to enlarge or diminish the predefined timeframe.

In one embodiment of the invention, a predefined number of last words from V_{presented} encountered are displayed on a pause screen. The number of words presented may depend on the size of the display.

In one embodiment of the invention, the multimedia content regarding the title may be stored in mobile device 150. Thus, the stream set-up and starting phases may be omitted and replaced with the streaming of the multimedia content from a memory associated with mobile device 150.

In one embodiment of the invention, the internal functions of vocabulary server 153 are performed in mobile device 150. Mobile device 150 only requests the vocabulary from vocabulary server 153 using the title information and/or metadata, for example, a movie name, a content identification code (ID). Vocabulary server 153 may perform an initial reduction of the vocabulary based on skill information obtained from mobile device 150.

FIG. 1B is a block diagram illustrating the determining of user skill in vocabulary and grammar by a vocabulary and grammar server together with a mobile device and the streaming of content to a separate display device, in one embodiment of the invention.

In FIG. 1B the starting point is that mobile device 150 is in communication with a server 152B, which runs a language learning application, for the learning of vocabulary, idioms and grammar, as illustrated with box 153B.

Mobile device 150 has a user interface (not shown), for example, a WWW or a WAP browser, which sends content requests comprising, for example, Uniform Resource Locator (URL), as illustrated with arrow 110. Server 152B replies with content comprising, for example, WWW or WAP pages, images, video, audio, animation and scripts. The content provided from server 152B is illustrated with arrow 111. The exchange of requests and content forms a language learning content service from the point of view of user 150. Language learning application 153B also performs the task of determining of the initial skill of the user of mobile device 150 in a given language, as illustrated with box 112, which corresponds to the functions of box 100 in FIG. 1A. The language learning application 153B also performs the presentation of a user interface, via which the user may choose a title, that is, a media presentation, as the basis for language self-study. The title may be chosen by the user from a list presented by server 152B. The title may be a movie, an audio recording, a video recording, a multimedia presentation, a song, a map, a text, a game or any combination of the aforementioned, or any other subject matter relevant for language self-study. In one embodiment, the list presented by the server may be a program/service listing, such as an Electronic Program Guide (EPG) or an Electronic Service Guide (ESG).

Via the user interface provided by server 152B, the user may select an identifier and/or metadata of the title. The user skill is maintained by server 152B between the requests from mobile device 150. Upon receiving the title identification, vocabulary server 152 maps the title to a vocabulary V, which is represented as a set of words V={w1, . . . , wn}. The user skill obtained in the request message is also mapped to a skill based vocabulary, that is, word set Vₛₖᵢₗₗ. A vocabulary may be represented as a text file where the words are separated by white space. In a vocabulary file the words may also be accompanied with their rank as determined from relative word frequencies in a sufficiently large corpus of texts. The vocabulary files may comprise only the word stems where different word endings, that is, inflectional morphemes are removed. The vocabulary may also be enhanced with idioms, phrases, grammar examples and verb usage examples, which are treated hereinafter as words. Thereupon, from the set V is removed all words that belong to the set Vₛₖᵢₗₗ to obtain a new set V_{filtered}, which represents the vocabulary in the title mastered by the user at her skill level and which may be omitted from the vocabulary guidance presented to the user during the playback or the presentation of the title.

In one embodiment of the invention, the words omitted from V_{filtered} are determined by mapping the user skill to a word rank above which all words are removed from the vocabulary V. For example, the 2000 most common words could be removed from the vocabulary V to yield the vocabulary V_{filtered} for a user with a skill level “intermediate=2”.

However, in order to avoid the spoiling of the plot in the title, it may be necessary to introduce additional vocabulary to the V_{filtered}, which is illustrated with box 113. The introducing of additional vocabulary is achieved, for example, so that keywords critical to the plot are identified in vocabulary V_{filtered} and are used to add extra theme related words and possibly idioms to vocabulary V_{filtered}, which serve the purpose of concealing plot details. For example, for each identified word wₚ is determined a set V_{theme(wp)} by mapping word wₚ to the set V_{theme(wp)}. The set V_{theme(wp)} is added to the set V_{filtered} to yield the set V_{enlarged}. The set V_{theme(wp)} does not necessarily have to contain merely words related to the subject matter or theme of word wₚ, instead the set V_{theme(wp)} may contain words related to alternative plots and denouements. The sensitive words are marked manually, for example, by associating a sensitivity indicator bit with them. In one embodiment of the invention, extra words for plot concealment are added in one phase provided that at least one plot sensitive word remains in the set V_{filtered}. In one embodiment of the invention, the critical keywords V_{theme(wp)} of the plot are used as a minimum content of the V_{enlarged} to provide enjoyable presentation to a user.

After V_{enlarged} has been determined, the user may start practicing the vocabulary via the user interface and server 152B. Language learning application 153B uses vocabulary V_{enlarged} or V_{filtered} and presents the words to the user together with their translations, usages, grammars and/or associated pictures. The words may be provided in a variety orders in order to conceal or reveal the plot better. Finally, application 153B presents a quiz to the user to determine the skill regarding the vocabulary associated with the title. This phase is illustrated with box 114. The skill regarding the title may be represented as a score, for example, from 0% to 100% or simply as the set of words mastered. The user may not be allowed to proceed to the playback of the title before a threshold number of words are mastered or before the score exceeds a predefined threshold. In another embodiment of the invention the application 153B may enable playback of the title and obtained vocabulary immediately without any pre-practicing. The practicing may be requested after the playback and/or if the skill level after the playback doesn't improve.

In one embodiment of the invention, the score is mapped to a cutoff word rank. The words having a rank lower than the cutoff word rank are removed from vocabulary V_{enlarged} to yield the final vocabulary V_{presented}, which represents the words the translation of which is shown in the subtitles during the playback of the title.

In one embodiment of the invention, the set of words mastered are removed from the vocabulary V_{enlarged} to yield the final vocabulary V_{presented}, which represents the words the translation of which is shown in the subtitles during the playback of the title.

Upon completing the quiz in language learning application 153B, server 152B sends a streaming request to a streaming server 154B, as illustrated with arrow 115. The streaming request may also be sent first to a display device 150B, which is separate from mobile device 150, as illustrated with arrow 116. Display device 150B then forwards the request to streaming server 154B. The display device 150B may comprise, for example, a set-top box and a display. Upon receiving the streaming request, streaming server 154B starts sending the multimedia presentation corresponding to the title. The correct video and audio objects are streamed to the user. In addition to the video and audio streams, a connection or a stream for subtitle texts is also provided to display device 150B from streaming server 154B.

The optional presentation of words, idioms and grammar structures may be embedded to the video media component either in streaming server 154B or in display device 150B. As words, idioms or grammar structures not belonging to the final vocabulary V_{presented} are encountered in the subtitle stream, they are erased. As words, idioms or grammar structures belonging to the final vocabulary V_{presented} are encountered in the subtitle data stream, the words are amended with a corresponding translation.

FIG. 1C is a block diagram illustrating the determining of user skill in vocabulary and grammar and the presentation of media content to a mobile device from a secondary memory in association with the mobile device, in one embodiment of the invention.

In FIG. 1C the language learning application 153B functions comprising, for example, an initial skill determination 121, vocabulary enlargement functions 122, title skill determination 124 and the forming of the final vocabulary V_{presented} are performed in a language learning application 153C in mobile device 150 itself. The media presentation, that is, the title to be presented to the user is stored in a secondary memory 125. The media presentation stored comprises the media components such as video, audio and subtitle texts. The optional presentation of words, idioms and grammar structures may be embedded to the video media component at supplementary content formation 126. As words, idioms or grammar structures not belonging to the final vocabulary V_{presented} are encountered in the subtitle stream they are not forwarded to presentation on the display. As words, idioms or grammar structures belonging to the final vocabulary V_{presented} are encountered in the subtitle data stream, the words are amended with a corresponding translation. The subtitles, that is, supplementary content may also be presented as a separate supplementary content window on the display of mobile device 150. The supplementary content is fed to a display entity 127 in the electronic device. The secondary memory 125 may be a removable memory medium such as an optical disk or a magnetic disk or a flash-memory or a holographic memory.

In one embodiment of the invention, the vocabulary V or a filtered vocabulary is obtained from a network server (not shown) using a title or an identifier of the media presentation as a parameter of a URL. At least one user related skill level may be provided to the network server to determine the filtered vocabulary. In one embodiment of the invention, the vocabulary V is read from the secondary memory 125.

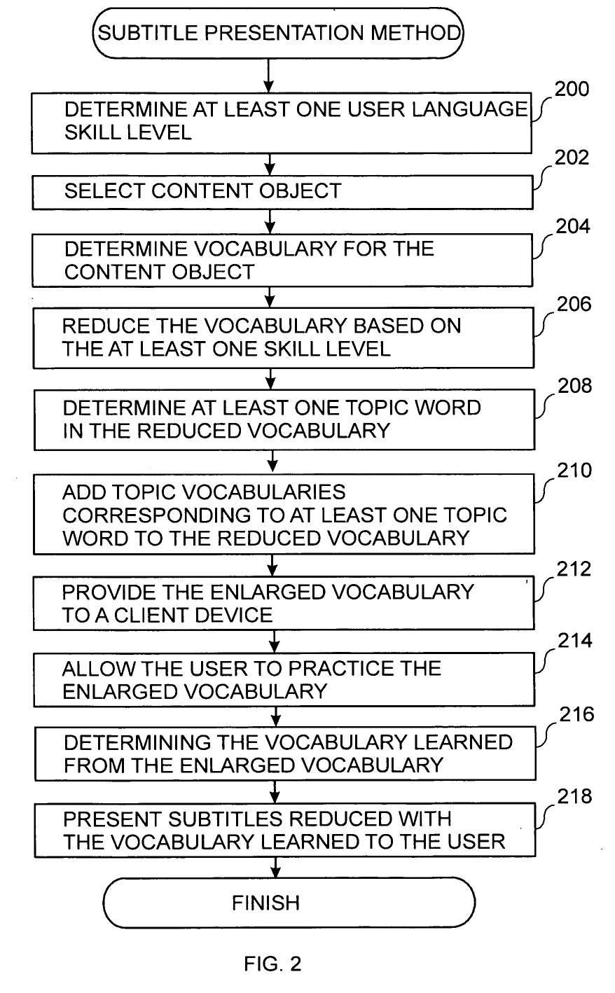

FIG. 2 is a flow chart illustrating a method for supplementary content, such as subtitle text, determination in one embodiment of the invention. Order of the described method steps may vary, and not all steps are necessary for the method.

At step 200, at least one user language skill level is determined.

In one embodiment of the invention, the at least one language skill level is determined with a test application running in a client device.

At step 202, the user selects a title, such as a content object, with the client device. The content object may be, for example, an audio recording, a video recording, an audiovisual recording, an animated video stream with audio, an electronic book, or radio/television broadcasting. The content object may also be a text file, a map or a computer game.

At step 204, the vocabulary for the content object is determined.

At step 206, the vocabulary is adjusted, e.g. reduced or enlarged, based on the at least one user language skill level.

In one embodiment of the invention, the at least one user language skill level is mapped to a word rank, which determines the words having a too low rank to be included in the reduced vocabulary, in other words, the filtered vocabulary.

In one embodiment of the invention, the mapping does not use word ranks. The at least one skill level is mapped to set of words which is subtracted from the vocabulary for the content object.

At step 208, at least one topic word is determined in the reduced vocabulary.

In one embodiment of the invention, the topic words have associated with them a tag or an indicator, which reveals that the topic words should, when remaining in the reduced vocabulary, be used as a basis for adding other similar words, the purpose of which is to conceal or make difficult to deduce the plot and important isolated events.

At step 210, word sets corresponding to the remaining topic words are added to the reduced vocabulary to produce an enlarged vocabulary. A word set may also be empty.

At step 212, the enlarged vocabulary is provided to a client device. In one embodiment of the invention, each word in the vocabulary is accompanied with its translation.

At step 214, the user is allowed using an application in the client device, to practice the vocabulary.

At step 216, the user is allowed to take a test to determine the vocabulary learned.

In one embodiment of the invention, the result of the test may be a further skill score, which is used to determine a further rank that tells to remove words having a lower rank from the enlarged vocabulary to obtain a vocabulary to be presented.

In one embodiment of the invention, the words that the user has proven to know in the test are removed from the enlarged vocabulary to obtain a vocabulary to be presented.

In another embodiment of the invention the steps 214 and 216 may be executed after presentation of the selected content object and obtained vocabulary.

At step 218, the streaming of the content object is started and the subtitles obtained regarding the content object are reduced by presenting only those words and their translations that remain in the vocabulary to be presented.

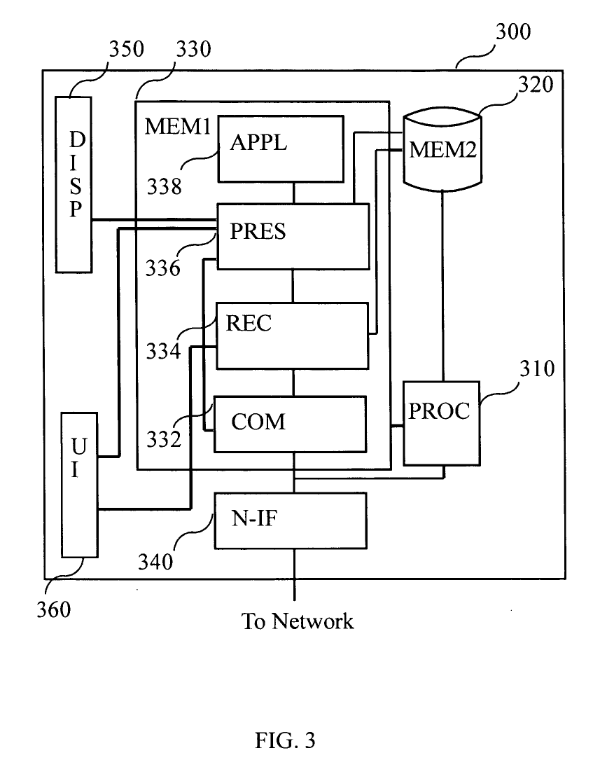

FIG. 3 is a block diagram illustrating an electronic device in one embodiment of the invention.

In FIG. 3 there is illustrated an electronic device 300. Electronic device 300 comprises a processor 310, a secondary memory 320, a primary memory 330, a display 350 and a user interface 360 such as a keypad. The secondary 320 and the primary 330 memories may include the title content i.e. the media content and the obtained vocabulary. Electronic device 300 may also comprise any number of other processors and any number secondary memory units. There may also be other primary memories with separate address spaces. Electronic device 300 comprises also a network interface 340. Network interface may, for example, be a cellular radio interface, a Wireless Local Area Network (WLAN) interface, a local area network interface or a wide area network interface. Additionally, the device 300 may also comprise one or more receiving interfaces (i.e. receivers) for receiving radio and/or television broadcasting content. Processor 310 executes a number of software entities stored at least partly in primary memory 330. Primary memory 330 comprises a communication entity 332, a multimedia reception entity 334, a media presentation entity 336 and a language learning entity, that is, an application entity 338. The language learning entity 338 may comprise the applications 100 and 104 as illustrated in FIG. 1. In one embodiment of the invention, language learning entity 338 also comprises the functions presented in box 102 of FIG. 1. Communication entity 332 communicates with remote network nodes for enabling them to communicate with other entities within electronic device 300. Communication entity 332 comprises, for example, the Internet Protocol (IP) protocol stack. Media presentation entity 336 communicates with language learning entity 338 in order to determine what words are to be presented in subtitle texts.

The entities within electronic device 300 such as communication entity 332, multimedia reception entity 334, multimedia presentation entity 336 and language learning entity 338 may be implemented in a variety of ways. They may be implemented as processes executed under the native operating system of the network node or the electronic device. The entities may be implemented as separate processes or threads or so that a number of different entities are implemented by means of one process or thread. A process or a thread may be the instance of a program block comprising a number of routines, that is, for example, procedures and functions. The entities may be implemented as separate computer programs or as a single computer program comprising several routines or functions implementing the entities. The program blocks are stored on at least one computer readable medium such as, for example, a memory circuit, a memory card, a holographic memory, magnetic or optic disk. Some entities may be implemented as program modules linked to another entity. The entities in FIG. 3 may also be stored in separate memories and executed by separate processors, which communicate, for example, via a message bus or an internal network within the network node or the electronic device. An example of such a message bus is the Peripheral Component Interconnect (PCI) bus. The internal network may be, for example, a local area network. The entities may also be partly or entirely implemented as hardware, such as ASICS or FPGAs.

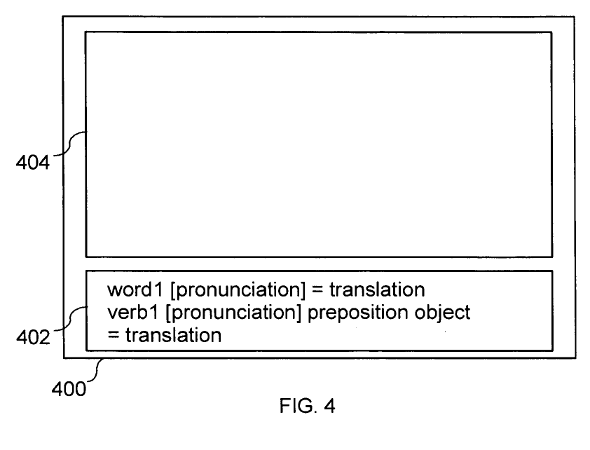

FIG. 4 is a block diagram illustrating a screen with supplementary content in one embodiment of the invention. In FIG. 4 there is a screen 400 for the presentation of a multimedia presentation. There is a first window 404, which is used to present the video of the multimedia presentation. There is also a second window 402, which is used to present the supplementary content formed in association with the media. On window 402 there is illustration the dictionary translations or definitions of an isolated word and a verb together with an associated preposition and an exemplary object.

In one embodiment of the invention, the second window 402 may be presented above, below or side of the first window 404. In one embodiment of the invention, second window 402 may be presented over or inside of the window 404. First window 402 may be enlarged or diminished based on user interface actions. In this embodiment, the use may decide and move the location of the second window 402. Alternatively, the media and/or the supplementary content provider may select a default position for the window 402.

In one embodiment of the invention, the supplementary content may be presented on a subtitle text field/area in the media content.

The exemplary embodiments of the invention can be included within any suitable device, for example, including any suitable servers, workstations, PCs, laptop computers, personal digital assistants (PDA), Internet appliances, handheld devices, cellular telephones, audio/video players, radio/television receivers, positioning devices (such as Global Positioning System (GPS) devices), still/video cameras, electronic book devices, wireless devices, other devices, and the like, or any combination of the aforementioned capable of performing the processes of the exemplary embodiments, and which can communicate via one or more interface mechanisms, including, for example, Internet access, telecommunications in any suitable form (e.g., voice, modem, and the like), wireless communications media, one or more wireless communications networks, cellular communications networks, G3 communications networks, Public Switched Telephone Network (PSTNs), wireless local area networks, (WLAN), short range wireless networks (such as Bluetooth®), Packet Data Networks (PDNs), the Internet, intranets, a combination thereof, and the like.

It is to be understood that the exemplary embodiments are for exemplary purposes, as many variations of the specific hardware used to implement the exemplary embodiments are possible, as will be appreciated by those skilled in the hardware art(s). For example, the functionality of one or more of the components of the exemplary embodiments can be implemented via one or more hardware devices.

The exemplary embodiments can store information relating to various processes described herein. This information can be stored in one or more memories, such as a hard disk, optical disk, magneto-optical disk, RAM, and the like. One or more databases can store the information used to implement the exemplary embodiments of the present inventions. The databases can be organized using data structures (e.g., records, tables, arrays, fields, graphs, trees, lists, and the like) included in one or more memories or storage devices listed herein. The processes described with respect to the exemplary embodiments can include appropriate data structures for storing data collected and/or generated by the processes of the devices and subsystems of the exemplary embodiments in one or more databases.

All or a portion of the exemplary embodiments can be implemented by the preparation of application-specific integrated circuits or by interconnecting an appropriate network of conventional component circuits, as will be appreciated by those skilled in the electrical art(s).

As stated above, the components of the exemplary embodiments can include computer readable medium or memories according to the teachings of the present inventions and for holding data structures, tables, records, and/or other data described herein. Computer readable medium can include any suitable medium that participates in providing instructions to a processor for execution. Such a medium can take many forms, including but not limited to, non-volatile media, volatile media, transmission media, and the like. Non-volatile media can include, for example, optical or magnetic disks, magneto-optical disks, and the like. Volatile media can include dynamic memories, and the like. Transmission media can include coaxial cables, copper wire, fiber optics, and the like. Transmission media also can take the form of acoustic, optical, electromagnetic waves, and the like, such as those generated during radio frequency (RF) communications, infrared (IR) data communications, and the like. Common forms of computer-readable media can include, for example, a floppy disk, a flexible disk, hard disk, magnetic tape, any other suitable magnetic medium, a CD-ROM, CDRW, DVD, any other suitable optical medium, punch cards, paper tape, optical mark sheets, any other suitable physical medium with patterns of holes or other optically recognizable indicia, a RAM, a PROM, an EPROM, a FLASH-EPROM, any other suitable memory chip or cartridge, a carrier wave or any other suitable medium from which a computer can read.

While the present inventions have been described in connection with a number of exemplary embodiments, and implementations, the present inventions are not so limited, but rather cover various modifications, and equivalent arrangements, which fall within the purview of prospective claims.

It is obvious to a person skilled in the art that with the advancement of technology, the basic idea of the invention may be implemented in various ways. The invention and its embodiments are thus not limited to the examples described above; instead they may vary within the scope of the claims.

1. A method comprising:
determining at least one initial language skill parameter in an electronic device;
selecting a content object for presentation in said electronic device;
determining a learning content associated with said content object;
adjusting said learning content based on said at least one initial language skill parameter to obtain a target learning content; and
presenting said target learning content in association with of said content object in said electronic device, said target learning content having a presentation timing dependent on said content object.

2. The method according to claim 1, wherein said learning content comprises at least one of a content vocabulary and a content grammar.

3. The method according to claim 2, wherein said learning content comprises at least one of a translation of at least one word present in said learning content, at least one illustration of at least one word present in said learning content, an example of use of a grammar structure and a translation of said grammar structure.

4. The method according to claim 1, wherein said presenting step further comprises:
detecting a presence of an expression in said content object; and
presenting for a predefined time a definition or a translation of said expression on a display of said electronic device, if said expression belongs to said target learning content.

5. The method according to claim 4, the method further comprising:
detecting a critical word in said target learning content or said learning content;
determining an additional vocabulary related to said critical word; and
adding said additional vocabulary to said target learning content or said learning content.

6. The method according to claim 1, the method further comprising:
presenting at least one word from said target learning content and a translation of said at least one word on said electronic device;
determining at least one second language skill parameter in said electronic device; and
reducing said target learning content based on said at least one second language skill parameter.

7. The method according to claim 1, wherein said reducing step comprises:
associating a rank with each word or expression in said learning content;
determining a rank based on said at least one initial language skill parameter; and
removing each word or expression with a rank lower than said rank.

8. The method according to claim 1, the method further comprising:
requesting said learning content from a vocabulary server, said request comprising said at least one initial language skill parameter and a title of said content object; and
receiving said target learning content to said electronic device.

9. The method according to claim 1, the method further comprising:
requesting the streaming of said content object from a streaming server; and
providing at least one stream associated with said content object from said streaming server.

10. The method according to claim 1, the method further comprising:
detecting the pressing of a key in said electronic device;
determining the current displacement from the start of the content object in content presentation;
determining at least one word or expression present in the content object during a predefined time period before the current displacement; and
presenting said at least one word or expression and a translation of said word or expression on a display of said electronic device.

11. The method according to claim 1, the method further comprising:
detecting the pressing of a key in said electronic device;
determining a current scene in the content object;
determining at least one word or expression presented during the scene; and
presenting said at least one word or expression and a translation of said word on a display of said electronic device.

12. The method according to claim 1, wherein said content object comprises at least one of: an audiovisual recording, a video recording, an audio recording, a text file or a computer game.

13. The method according to claim 1, wherein said electronic device comprises a mobile communication device.

14. A system comprising:
a network server configured to determine at least one initial language skill parameter, to select a content object for presentation by an electronic device, to determine a learning content associated with said content object, to adjust said learning content based on said at least one initial language skill parameter to obtain a target learning content, and to provide said target learning content to said electronic device; and
said electronic device configured to present said target learning content in association with said content object, said target learning content having a presentation timing dependent on said content object.

15. An electronic device comprising:
an application entity configured to determine at least one initial language skill parameter, to select a content object for presentation, to determine a learning content associated with said content object, to adjust said learning content based on said at least one initial language skill parameter to produce a target learning content; and
a media presentation entity configured to present said target learning content in association with said content object, said target learning content having a presentation timing dependent on said content object.

16. The electronic device according to claim 15, wherein said learning content comprises at least one of a content vocabulary and a content grammar.

17. The electronic device according to claim 15, wherein said learning content comprises at least one of a translation of at least one word present in said learning content, at least one illustration of at least one word present in said learning content, an example of use of a grammar structure and a translation of said grammar structure.

18. The electronic device according to claim 15, the electronic device further comprising:
said media presentation entity configured to start a presentation of said content object, to detect a presence of a word or an expression in said content object, and to present for a predefined time a translation or a definition of said word or expression on a display of said electronic device, if said word or expression belongs to said target learning content.

19. The electronic device according to claim 15, the electronic device further comprising:
said application entity configured to detect a critical word in said target learning content or said learning content, to determine an additional vocabulary related to said critical word and to add said additional vocabulary to said target learning content or said learning content.

20. The electronic device according to claim 15, the electronic device further comprising:
said application entity configured to present at least one word from said target learning content and a translation of said at least one word, to determine at least one second language skill parameter and to reduce said target learning content based on said at least one second language skill parameter.

21. The electronic device according to claim 15, the electronic device further comprising:
said application entity configured to associate a rank with each word in said learning content, to determine a rank based on said at least one initial language skill parameter, to remove each word with a rank lower than said rank.

22. The electronic device according to claim 15, the electronic device further comprising:
said application entity configured to request said learning content from a vocabulary server, said request comprising said at least one initial language skill parameter and a title of said content object; and to receive said target learning content to said electronic device.

23. The electronic device according to claim 15, the electronic device further comprising:
a multimedia reception entity configured to request the streaming of said content object from a streaming server, to receive at least one stream associated with said content object from said streaming server.

24. The electronic device according to claim 15, the electronic device further comprising:
said multimedia presentation entity configured to detect the pressing of a key, to determine the current displacement from the start of the content object in said content presentation, to determine at least one word or expression presented in the content object during a predefined time period before the current displacement and to present said at least one word or expression and a translation of said word or expression on a display of said electronic device.

25. The electronic device according to claim 15, the electronic device further comprising:
said multimedia presentation entity configured to detect the pressing of a key, to determine a current scene in the content object, to determine at least one word or expression presented during the scene and to present said at least one word or expression and a translation of said at least one word or expression on a display of said electronic device.

26. The electronic device according to claim 15, the electronic device further comprising:
said application entity configured to provide said at least one initial language skill parameter to a remote server.

27. The electronic device according to claim 15, wherein said content object comprises at least one of: an audiovisual recording, a video recording, an audio recording, a text file or a computer game.

28. The electronic device according to claim 15, wherein said electronic device comprises a mobile communication device.

29. An electronic device comprising:
means for determining at least one initial language skill parameter;
means for selecting a content object for presentation;
means for determining a learning content associated with said content object;
means for adjusting said learning content based on said at least one initial language skill parameter to produce a target learning content; and
means for presenting said target learning content in association with of said content object, said target learning content having a presentation timing dependent on said content object.

30. An electronic device comprising:
an application entity configured to determine at least one initial language skill parameter, to select a content object for presentation, to locate a learning content associated with said content object and said at least one initial language skill parameter; and
a media presentation entity configured to present said target learning content in association with of said content object, said target learning content having a presentation timing dependent on said content object.

31. An electronic device comprising:
means for determining at least one initial language skill parameter;
means for selecting a content object for presentation;
means for obtaining a learning content associated with said content object and said at least one initial language skill parameter;
means for presenting said target learning content in association with of said content object, said target learning content having a presentation timing dependent on said content object.

32. A computer program embodied on a computer readable medium, the computer program comprising code for controlling a processor to execute a method comprising:
determining at least one initial language skill parameter in an electronic device;
selecting a content object for presentation in said electronic device;
determining a learning content associated with said content object;
adjusting said learning content based on said at least one initial language skill parameter to produce a target learning content; and
presenting said target learning content in association with of said content object, said target learning content having a presentation timing dependent on said content object.

33. The computer program according to claim 32, wherein said computer readable medium is a removable memory card.

34. The computer program according to claim 32, wherein said computer readable medium is a magnetic or an optical disk or a holographic memory.

35. A computer program embodied on a computer readable medium, the computer program comprising code for controlling a processor to execute a method comprising:
determining at least one initial language skill parameter;
selecting a content object for presentation;
locating a learning content associated with said content object;
obtaining a target learning content based on said at least one initial language skill parameter; and
presenting said target learning content in association with of said content object, said target learning content having a presentation timing dependent on said content object.

36. The computer program according to claim 35, wherein said computer readable medium is a removable memory card.

37. The computer program according to claim 35, wherein said computer readable medium is a magnetic or an optical disk or a holographic memory.
